(19) United States
(12) Patent Application Publication
(10) Pub. No.: US 2025/0147826 A1
(43) Pub. Date: May 8, 2025

(54) MESSAGE EXECUTION AND PROCESSING METHOD, DEVICE, ELECTRONIC DEVICE, AND STORAGE MEDIUM

(71) Applicant: SHENZHEN TCL NEW TECHNOLOGY CO., LTD., Shenzhen, Guangdong (CN)

(72) Inventor: Hangzhi ZHANG, Shenzhen, Guangdong (CN)

(73) Assignee: SHENZHEN TCL NEW TECHNOLOGY CO., LTD., Shenzhen, Guangdong (CN)

(21) Appl. No.: 18/837,602

(22) PCT Filed: Feb. 1, 2023
(86) PCT No.: PCT/CN2023/074150

§ 371 Date: Aug. 11, 2024

(30) Foreign Application Priority Data
Feb. 11, 2022 (CN) 202210127687.X

(51) Int. Cl. G06F 9/54

(52) U.S. Cl. CPC G06F 9/546; G06F 2209/548

(57) ABSTRACT

A message execution and processing method, a device, an electronic device, and a storage medium are provided. A message to be executed in a message queue is acquired. The message to be executed is detected based on a preset type flag to obtain a detection result. A target message to be executed with the preset type flag in the message to be executed is identified based on the detection result. Execution position information of the target message to be executed in the message queue is updated to obtain an updated message to be executed, which improves an efficiency of message execution.

This application claims priority to Chinese Patent Application No. 202210127687.X, filed Feb. 11, 2022 and entitled “MESSAGE EXECUTION AND PROCESSING METHOD, DEVICE, ELECTRONIC DEVICE, AND STORAGE MEDIUM”. The entire disclosures of the above application are incorporated herein by reference.

### TECHNICAL FIELD

This application relates to the field of communication technologies, specifically to a message execution and processing method, a device, an electronic device, and a storage medium.

### BACKGROUND TECHNOLOGY

Current electronic devices generally rely on an operating system to implement various functions, and an operation of the operating system is generally inseparable from a message mechanism. The message mechanism drives an execution of various processes in the system. For example, a running of applications in the electronic devices, a running of system services, etc. are all driven by the message mechanism. Among various events generated by the electronic devices, there are often some events that are easy for users to perceive and have high execution urgency. At this time, it is necessary to increase an execution priority of messages corresponding to these events. In the existing technology, the priority of the event is often increased by increasing the priority of the message in a main thread. When the priority of the message in the main thread is increased, the system will allocate more resources to the main thread, thereby reducing a delay of the message. However, it does not fundamentally solve a problem of message lag.

### Technical Problem

There is a message lag problem in the operating system.

### SUMMARY OF INVENTION

Embodiments of present application propose a message execution and processing method, a device, an electronic device, and a storage medium, which can solve the problem of message lag, thereby improving an efficiency of message execution and processing.

An embodiment of present application provides a message execution and processing method, including:
acquiring at least one message to be executed in a message queue;
detecting the at least one message to be executed based on a preset type flag to obtain a detection result;
identifying a target message to be executed with the preset type flag in the at least one message to be executed based on the detection result; and
updating execution position information of the target message to be executed in the message queue to obtain an updated message to be executed.

Correspondingly, an embodiment of the present application also provides a message execution and processing device, including:
an acquisition unit configured to acquire at least one message to be executed in a message queue;
a detection unit configured to detect the at least one message to be executed based on a preset type flag to obtain a detection result;
an identification unit configured to identify a target message to be executed with the preset type flag in the at least one message to be executed based on the detection result; and
an update unit configured to update execution position information of the target message to be executed in the message queue to obtain an updated message to be executed.

In one embodiment, the detection unit may include:
a parsing subunit configured to parse the message to be executed to obtain a message structure of the message to be executed, where the message structure includes a plurality of structural parameters;
a matching subunit configured to match the preset type flag and the structural parameters to obtain a matching result; and
a generating subunit configured to generate the detection result according to the matching result.

In one embodiment, the update unit may include:
an information determination subunit configured to determine target update position information of the target message to be executed based on the execution position information;
a message determination subunit configured to determine an associated message to be executed associated with the target update position information;
an information adjustment subunit configured to adjust execution position information of the associated message to be executed; and
an information update subunit configured to update the execution position information of the target message to be executed to the target update position information to obtain the updated message to be executed.

In one embodiment, the detection unit is configured to:
detect the at least one message to be executed based on a preset paint type flag to obtain the detection result.

In one embodiment, the identification unit is configured to:
identify a target paint message to be executed with the preset paint type flag in the at least one message to be executed based on the detection result.

In one embodiment, the update unit is configured to:
update execution position information of the target paint message to be executed in the message queue to obtain the updated message to be executed.

In one embodiment, the message execution and processing device in the embodiment of the present application may also include:
a calling unit configured to call a main thread to execute the updated message to be executed.

In one embodiment, the message execution and processing device may include:
a message identification unit configured to identify a generated message to obtain a type of the generated message;
an identification unit configured to perform an identifying processing on the generated message to obtain a flagged message if the type of the generated message is a preset target type;
an addition unit configured to add the flagged message to the message queue.

In one embodiment, the identification unit may include:
a message identification subunit configured to identify the generated message to obtain a message structure of the generated message if the type of the generated message is the preset target type;
a field addition subunit configured to add a preset type identification field to the message structure of the generated message to obtain an initial identification message;
an activation subunit configured to activate the preset type identification field of the initial identification message to obtain the flagged message.

Correspondingly, an embodiment of the present application also provides an electronic device. The electronic device includes a memory and a processor, the memory stores a computer program, and the processor is configured to run the computer program in the memory to perform the message execution and processing method provided by any of the embodiments of the present application.

Correspondingly, an embodiment of the present application also provides a storage medium, the storage medium stores a computer program, and when the computer program is executed by the processor, the message execution and processing method provided by any of the embodiments of the present application is implemented.

### Beneficial Effects

The embodiments of present application can acquire at least one message to be executed in the message queue. Based on the preset type flag, the at least one message to be executed is detect to obtain the detection result. Based on the detection result, the target message to be executed with the preset type flag is identified in the at least one message to be executed. The execution position information of the target message to be executed in the message queue is updated to obtain the updated message to be executed, which improves an efficiency of message execution.

### BRIEF DESCRIPTION OF THE DRAWINGS

In order to more clearly illustrate technical solutions in the embodiments of the present application, the following drawings that will be described in the embodiments are briefly introduced. It is obvious that the drawings described below are merely some embodiments of the present application, those skilled in the art can obtain other drawings according to these drawings without creative efforts.

FIG. 1 is a schematic diagram of a message execution and processing method provided by an embodiment of the present application.

FIG. 2 is a flowchart of a message execution and processing method provided by an embodiment of the present application.

FIG. 3 is a schematic diagram of a message queue of a message execution and processing method provided by an embodiment of the present application.

FIG. 4 is another flowchart of a message execution and processing method provided by an embodiment of the present application.

FIG. 5 is another flowchart of a message execution and processing method provided by an embodiment of the present application.

FIG. 6 is a schematic structural diagram of a message execution and processing device provided by an embodiment of the present application.

FIG. 7 is a schematic structural diagram of an electronic device provided by an embodiment of the present application.

### DETAILED DESCRIPTION OF THE PREFERRED EMBODIMENTS

The technical solutions in the embodiments of the present disclosure will be clearly and completely described below with reference to the accompanying drawings in the embodiments of the present disclosure. However, the described embodiments are only some, but not all, embodiments of the present disclosure. Based on the embodiments in the present disclosure, all other embodiments obtained by those skilled in the art without creative efforts shall fall within the protection scope of the present disclosure.

An embodiment of the present application proposes a message execution and processing method. The message execution and processing method can be executed by a message execution and processing device. The message execution and processing device can be integrated in an electronic device. The electronic device may include at least one of a terminal and a server. That is, the message execution and processing method can be executed by the terminal or the server.

The terminal can include personal computers, tablets, smart TVs, smartphones, smart homes, wearable electronic devices, VR/AR devices, vehicle-mounted computers, etc.

The server can be an interworking server or a backend server between multiple heterogeneous systems, or it can be an independent physical server, or it can be a server cluster or distributed system composed of multiple physical servers, or it can be a cloud server that provides basic cloud computing services such as cloud services, cloud databases, cloud computing, cloud functions, cloud storage, network services, cloud communications, middleware services, domain name services, security services, and big data and artificial intelligence platforms, etc.

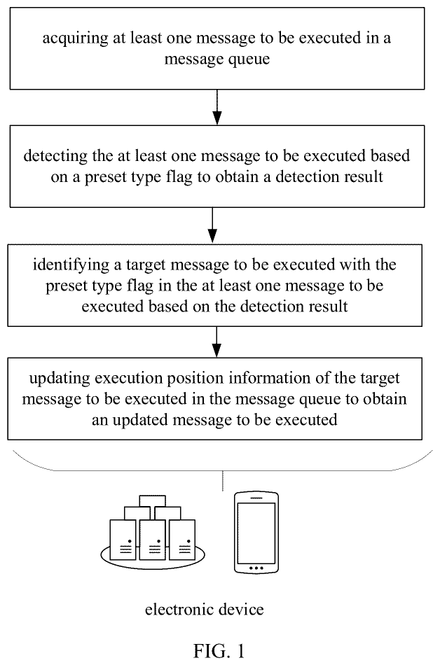

In one embodiment, as shown in FIG. 1, a message execution and processing device can be integrated on an electronic device such as a terminal or a server to implement the message execution and processing method proposed in the embodiment of the present application. Specifically, the electronic device can acquire at least one message to be executed in a message queue. Based on a preset type flag, the at least one message to be executed is detected to obtain a detection result. Based on the detection result, a target message to be executed with the preset type flag is identified in the at least one message to be executed. Execution position information of the target message to be executed in the message queue is updated to obtain an updated message to be executed.

Detailed descriptions are provided below. It should be noted that the order of description of the following embodiments is not intended to limit the preferred order of the embodiments.

The embodiments of present application will describe a message execution and processing method proposed in the embodiments of present application from a perspective that the message execution and processing device is integrated in the electronic device.

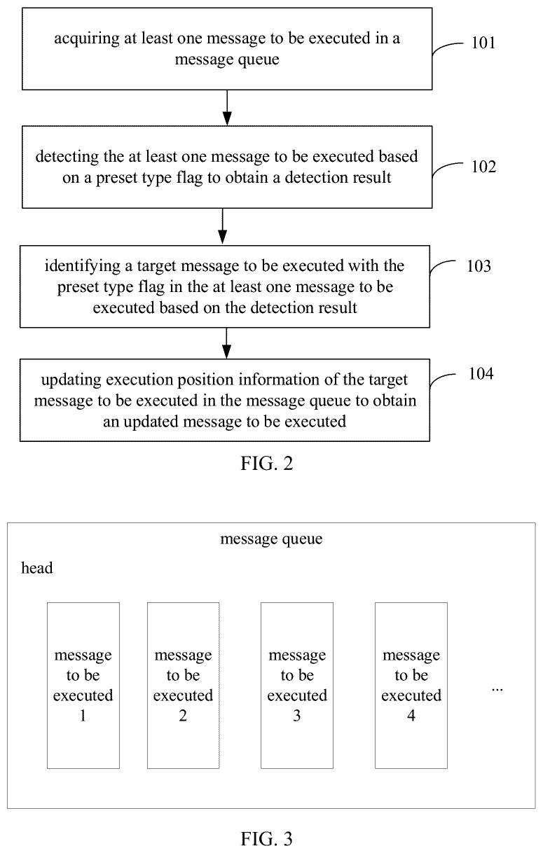

As shown in FIG. 2, a message execution and processing method is provided. The specific process includes the following:

101. At least one message to be executed in a message queue is acquired.

Current electronic devices generally rely on an operating system to implement various functions, and operations of the operating system are generally inseparable from a message mechanism. Everything that happens in the operating system can be identified by messages. The messages are configured to tell the operating system what happened. Applications in the operating system are generally driven by the messages.

For example, when a user clicks on a control of an application in an electronic device, the operating system receives a message. For another example, when the user turns on the electronic device, the operating system will also receive a message. For another example, when the user moves a mouse connected to the electronic device, the operating system will also receive a message, and so on.

In one embodiment, users may perform different operations on electronic devices, and some electronic devices may have automated operations. Therefore, electronic devices generate various different types of messages. For example, an electronic device may generate paint messages, input and output messages, storage messages, etc.

In one embodiment, among the messages generated by the electronic device, there are often some messages that are easy for users to perceive and have high execution urgency. For example, paint messages, etc.

The paint messages can refer to messages that will cause changes in a user interface design (UI) displayed by the electronic device. For example, the electronic device is a smart TV. When the user controls the smart TV via remote control and an interface of the smart TV changes, the operating system will receive the paint message. For another example, if the electronic device is a smartphone, when the user clicks on an application in the smartphone, causing a UE interface of the smartphone to change, the operating system will receive the paint message.

The operating system may include a computer program that manages the computer's hardware and software resources. For example, the operating system needs to handle basic tasks such as managing and configuring memory, determining the priority of system resource supply and demand, controlling input and output devices, operating a network, and managing a file system. The operating system also provides an operating interface for users to interact with the system.

For example, the operating system may include Linux system, iOS system, Android system, etc.

In one embodiment, the message mechanism of the operating system generally includes message queue, message processor, message, message loop (Looper), and thread. Among them, the Looper will be started when the thread starts. A main responsibility of the Looper is to cyclically retrieve the messages in the message queue (Message Queue) and execute the messages. When there are no messages in the message queue that need to be executed, the thread will sleep. When there is a message that needs to be executed, the thread is awakened and the Looper starts to retrieve the message and execute the message. During the execution of each message, or during the running of other threads, messages can be sent to the message queue through a message processor (Handler).

Therefore, the messages generated by the electronic device are generally stored in the message queue to wait for the main thread to read the message from the message queue and execute an event corresponding to the message.

The message to be executed can include a message stored in the message queue, waiting to be executed.

In one embodiment, in the prior art, when there are messages to be executed in the message queue that are easy for users to perceive and have high execution urgency, the delay of messages is often reduced by increasing the priority of messages in the main thread. However, existing technologies do not fundamentally solve the problem of message lag.

In the embodiment of the present application, the message execution and processing device will first acquire at least one message to be executed in the message queue, and then detect the message to be executed that is perceptible to the user, and update a position of the message to be executed in the message queue, thereby improving an execution priority of the message to be executed, preventing the problem of message to be executed lagging, and improving the efficiency of message execution.

102. Based on a preset type flag, the at least one message to be executed is detected to obtain a detection result.

In one embodiment, after the message execution and processing device acquires the at least one message to be executed in the message queue, it can detect the at least one message to be executed, thereby determining whether there is a message in the message to be executed that is easily perceivable by the user.

The message execution and processing device can detect the at least one message to be executed based on the preset type flag to obtain the detection result.

The preset type flag can be set in advance to detect whether the message to be executed contains a message that is easily perceivable by the user.

For example, when the message that is easy for users to perceive is a paint message, the preset type flag can be set to a preset paint type flag. Then, the preset paint type flag can be used to detect whether there is the paint message in the message to be executed.

In one embodiment, when the electronic device generates a message, the message execution processing device can perform an identifying processing on the message that is easily perceivable by the user, so that the message that is perceptible by the user has a type flag. Then, in a stage of executing the message, the message execution and processing device can detect at least one message to be executed based on the preset type flag and obtain the detection result.

The detection result can indicate whether there is a user-perceptible message in the message to be executed. The detection result has a variety of presentation forms. For example, the presentation form of the detection result can be True or False. True can mean that there is a message that is perceptible to the user in the message to be executed, while False can mean that there is no message that is perceptible to the user in the message to be executed. For another example, the presentation form of the detection result can be 1 or 0, where 1 can mean that there is a message that is perceptible to the user in the message to be executed, and 0 can mean that there is no message that is perceptible to the user in the message to be executed.

In an embodiment, one detection result can also be generated for each message to be executed. For example, assuming there are 10 messages to be executed in the message queue, 10 detection results can be generated, and each detection result corresponds to one message to be executed.

103. Based on the detection result, a target message to be executed with the preset type flag in the at least one message to be executed is identified.

In an embodiment, after the detection result is obtained, the target message to be executed with the preset type flag in the at least one message to be executed can be identified based on the detection result.

The target message to be executed can include a message that is perceptible to users. For example, the target message to be executed can include a paint message, etc.

In one embodiment, when the detection result shows that there is a user-perceivable message in the message to be executed, the message execution and processing device can determine the user-perceivable message in the message queue as the target message to be executed.

104. Execution position information of the target message to be executed in the message queue is updated to obtain an updated message to be executed.

In one embodiment, when it is detected that there is a message that is perceptible to the user in the message queue, the message execution and processing device can update the execution position information of the target message to be executed in the message queue to obtain the updated message to be executed, so as to increase the priority of the target message to be executed and prevent message lag problems. By updating the execution position information of the target message to be executed in the message queue, the target message to be executed can be executed quickly without causing lag problems.

For example, as shown in FIG. 3, the message queue includes four messages to be executed, namely message to be executed 1, message to be executed 2, message to be executed 3 and message to be executed 4.

It is detected that the message to be executed 4 is the target message to be executed. At this time, a position of the message to be executed 4 in the message queue can be adjusted. For example, the position of the message to be executed 4 is adjusted to a head of the message queue, so that the main thread can directly read the message to be executed 4 without traversing the message queue, thereby reducing the time it takes to traverse the message queue and improving the execution efficiency of the message that is easily perceived by users.

The embodiment of the present application proposes the message execution and processing method. The method includes: acquiring at least one message to be executed in a message queue; detecting the at least one message to be executed based on a preset type flag to obtain a detection result; identifying a target message to be executed with the preset type flag in the at least one message to be executed based on the detection result; and updating execution position information of the target message to be executed in the message queue to obtain an updated message to be executed. In the embodiment of the present application, by updating the execution position message of the target message to be executed in the message queue, the updated message to be executed can be quickly executed by the main thread. Compared with the existing technology, the embodiment of the present application does not require the main thread to traverse the message queue to extract the target message to be executed. Therefore, compared with the prior art, the embodiment of the present application can reduce the time for the main thread to traverse the message queue, thereby improving the efficiency of the main thread to execute messages that are easily perceivable by the user.

According to the method described in the above embodiments, examples will be given below for further detailed explanation.

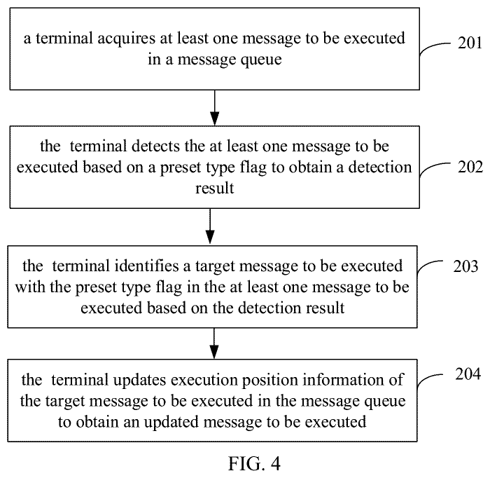

Embodiments of present application will take the message execution and processing method integrated on a terminal as an example to introduce implementations of present application. Specifically, as shown in FIG. 4, processes of the message execution and processing method proposed by the embodiments of the present application may include:

201. The terminal acquires at least one message to be executed in a message queue.

In one embodiment, the terminal generally relies on an operating system to implement various functions, and operations of the operating system are generally inseparable from a message mechanism. Everything that happens in the operating system can be identified by messages. The messages are used to tell the operating system what happened. Applications in the operating system are generally driven by the messages.

In one embodiment, the message mechanism of the operating system generally includes message queue, message processor, message, message loop (Looper), and thread. Among them, the Looper will be started when the thread starts. A main responsibility of the Looper is to cyclically retrieve the messages in the message queue (Message Queue) and execute the messages. When there are no messages in the message queue that need to be executed, the thread will sleep. When there is a message that needs to be executed, the thread is awakened and the Looper starts to retrieve the message and execute the message. During the execution of each message, or during the running of other threads, messages can be sent to the message queue through a message processor (Handler).

Therefore, the message generated by the terminal can be stored in the message queue to wait for the main thread to read the message from the message queue and execute an event corresponding to the message.

In order to solve the problem of message lag in the prior art and improve the execution efficiency of the message that is easy for users to perceive, before the main thread reads out the message to be executed in the message queue, the terminal can acquire at least one message to be executed in a message queue. Based on a preset type flag, the at least one message to be executed is detected to obtain a detection result. Based on the detection result, a target message to be executed with the preset type flag is identified in the at least one message to be executed. Execution position information of the target message to be executed in the message queue is updated to obtain an updated message to be executed.

In order for the terminal to correctly detect the target message to be executed in the message queue, the terminal can perform an identifying processing on the message that is easily perceptible to the user when the message is generated. Specifically, before the step “the terminal acquires at least one message to be executed in the message queue”, it includes:
identifying a generated message to obtain a type of the generated message;
if the type of the generated message is a preset target type, performing an identifying processing on the generated message to obtain a flagged message;
adding the flagged message to the message queue.

The generated message can refer to a message generated by the terminal.

In one embodiment, when the terminal generates the message, the operating system can acquire the generated message, identify the generated message, and obtain the type of the generated message.

For example, the generated message can be identified to determine whether the generated message is a paint message, an input message, an output message, and so on.

In one embodiment, after obtaining the type of the generated message, the type of the generated message can be defeminated to determine whether the type of the generated message is a preset target type.

The preset target type can include message types that are easily perceivable by users. For example, the preset target type can include a paint message type, etc.

There are many ways to identify the type of the generated message. For example, the type of the generated message can be matched with the preset target type. If they match, it means that the type of the generated message is the preset target type, otherwise it is not.

In one embodiment, in order for the terminal to correctly detect the target message to be executed in the message queue, when the type of the generated message is the preset target type, the identifying processing can be performed on the generated message to obtain a flagged message. For example, an identification can be directly added to the generated message.

In one embodiment, a field of the generated message can also be modified, so that at least one message to be executed can be detected based on the preset type flag, and the detection result can be obtained. Specifically, the step of “when the type of the generated message is the preset target type, performing an identifying processing on the generated message to obtain a flagged message” includes:
if the type of the generated message is the preset target type, identifying the generated message to obtain a message structure of the generated message;
adding a preset type identification field to the message structure of the generated message to obtain an initial identification message;
activating the preset type identification field of the initial identification message to obtain the flagged message.

In one embodiment, each message is composed of a message structure. The message structure can include the content that constitutes the message. There is a lot of message-related information in the message structure. For example, the message structure can include the type of message, the role of the message, the attributes of the message, and so on.

In one embodiment, after obtaining the message structure of the generated message, the preset type identification field can be added to the message structure of the generated message, so that the generated message carries a type identification.

The preset type identification field can be a field that is preset and added to the generated message. Adding the preset type identification field to the message structure of the generated message can be equivalent to increasing the priority of the generated message. Therefore, when the flagged message with the preset type identification field enters the message queue, execution position information of the to-be-executed information with the preset type identification field in the message can be updated, thereby improving the execution efficiency of the message that is easy for users to perceive.

For example, the message structure of the generated message originally includes: what, arg1, and arg2. When the type of the generated message is the preset target type, a vsync field can be added in the message structure of the generated message to obtain the initial identification message.

In one embodiment, after the initial identification message is obtained, the preset identification field of the initial identification message can be activated to obtain the flagged message.

Activating the preset identification field in the initial identification message can instruct the preset identification field in the initial identification message to be validated. For example, the operating system can send a global update command to update the message structure of the message. Then, the message structure of the initial identification information will be updated, and the preset identification field of the initial identification information will be valid.

In an embodiment, after obtaining the flagged message, the flagged message can be added to the message queue. When the flagged message enters the message queue, the flagged message will be used as the message to be executed.

202. Based on the preset type flag, the terminal detects the at least one message to be executed to obtain a detection result.

In one embodiment, during a message generation stage, the terminal adds the preset type identification field to the message. Therefore, during a message execution stage, the terminal can detect the at least one message to be executed in the message queue based on the preset type flag to obtain the detection result. Specifically, the step of “based on the preset type flag, detecting the at least one message to be executed to obtain a detection result” may include:
parsing the message to be executed to obtain a message structure of the message to be executed, wherein the message structure comprises a plurality of structural parameters;
matching the preset type flag and the structural parameters to obtain a matching result; and
generating the detection result according to the matching result.

In an embodiment, the message to be executed in the message queue may be first parsed to obtain the message structure of the message to be executed, where the message structure includes the plurality of structural parameters.

These structural parameters can refer to the contents of the message structure.

Then, the preset type flag and the structural parameters can be matched to obtain the matching result. For example, the preset type flag can be vsync. Then, the preset type flag and the structural parameters can be matched to determine whether the at least one message to be executed in the message queue has the target message to be executed.

In an embodiment, when the message type that is perceptible to the user is a paint message, the preset type flag may be a preset paint type flag. At this time, based on the preset paint type flag, the at least one message to be executed can be detected and the detection result can be obtained.

In addition, when the message type is the paint message, the identifying processing can be performed on the generated message whose type is the paint message in the generated message stage. For example, the vsync field can be added in the paint message to increase the priority of the paint message in the message queue.

203. Based on the detection result, the terminal identifies a target message to be executed with the preset type flag in the at least one message to be executed.

In an embodiment, the terminal can identify the target message to be executed with the preset type flag in the at least one message to be executed based on the detection result.

The target message to be executed can include a message that is perceptible to users. For example, the target message to be executed can include a paint message, etc.

In one embodiment, when the detection result shows that there is a user-perceivable message in the message to be executed, the message execution and processing device can determine the user-perceivable message in the message queue as the target message to be executed.

In an embodiment, when the message type that is perceptible to the user is a paint message, the target message to be executed may be the target paint message to be executed. At this time, the step of “based on the detection result, identifying a target message to be executed with the preset type flag in the at least one message to be executed” can include:

identifying a target paint message to be executed with the preset paint type flag in the at least one message to be executed based on the detection result.

204. The terminal updates execution position information of the target message to be executed in the message queue to obtain an updated message to be executed.

In one embodiment, after determining the target message to be executed, the terminal can update the execution position information of the target message to be executed in the message queue to obtain the updated message to be executed.

For example, when the target message to be executed is not at a head of the message queue, the terminal can update a position of the target message to be executed to the head of the message queue.

Specifically, the step of “updating execution position information of the target message to be executed in the message queue to obtain an updated message to be executed” include:
determining target update position information of the target message to be executed based on the execution position information;
determining an associated message to be executed associated with the target update position information;
adjusting execution position information of the associated message to be executed; and
updating the execution position information of the target message to be executed to the target update position information to obtain the updated message to be executed.

The target update position information can refer to the position of the target message to be executed in the message queue after updating the position of the target message to be executed. Generally, in order to prevent the lag of the target message to be executed and improve the priority and efficiency of the target message to be executed, the target message to be executed can be determined as the head of the message queue. The main thread generally executes the message to be executed at the head of the message queue. Therefore, determining the target message to be executed as the head of the message queue ensures that the target message to be executed can be executed immediately.

In one embodiment, when the execution position information of the target message to be executed is updated, the execution positions of other messages to be executed may be affected. The associated message to be executed can include the message to be executed whose execution position will be affected.

For example, there are four messages to be executed in the message queue, namely message to be executed 1, message to be executed 2, message to be executed 3, and message to be executed 4.

It is detected that the message to be executed 4 is the target message to be executed. At this time, a position of the message to be executed 4 in the message queue can be adjusted. For example, the position of the message to be executed 4 is adjusted to a head of the message queue, so that the main thread can directly read the message to be executed 4 without traversing the message queue.

If the message queue 4 to be executed is adjusted to the head of the message queue, it will affect the execution positions of the message to be executed 1, the message to be executed 2, and the message to be executed 3. At this time, the associated message to be executed may include the message to be executed 1, the message to be executed 2, and the message to be executed 3.

In one embodiment, when the execution position information of the target message to be executed is updated, the associated message to be executed may be affected. Therefore, the execution position information of the associated message to be executed is adjusted, and then the execution position information of the target message to be executed is updated to the target update position information to obtain the updated message to be executed.

For example, first, the associated message to be executed is placed in an empty queue, leaving the head of the message queue empty. Then, the target message to be executed is inserted into the head of the message queue. Then, according to an original execution order of the associated message to be executed, the associated message to be executed is added to the message queue.

In one embodiment, the target message to be executed can also be directly inserted into the head of the message queue to update the execution position information of the target message to be executed in the message queue and obtain the updated message to be executed.

In one embodiment, before updating the execution position information of the target message to be executed in the message queue, it may be determined whether the execution position of the target message to be executed in the message queue is at the target update position. If the execution position of the target message to be executed in the message queue is at the target update position, there is no need to update the execution position information of the target message to be executed in the message queue. Otherwise, the execution position information of the target message to be executed in the message queue needs to be updated.

In an embodiment, when the message type that is perceptible to the user is a paint message, the target message to be executed may be the target paint message to be executed. At this time, the step of “updating execution position information of the target message to be executed in the message queue to obtain an updated message to be executed” include:

The execution position information of the target paint message to be executed in the message queue is updated and to obtain the updated message to be executed.

In one embodiment, after g obtaining the updated message to be executed, the main thread can be called to execute the updated message to be executed. Specifically, the method proposed in the embodiment of the present application also includes:
calling a main thread to execute the updated message to be executed.

Since the updated message to be executed is at the head of the message queue, the main thread can immediately obtain the updated message to be executed without traversing the message queue. This improves the problem of execution delay of messages that are easily perceived by users, and improves the execution efficiency of messages that are easily perceived by users.

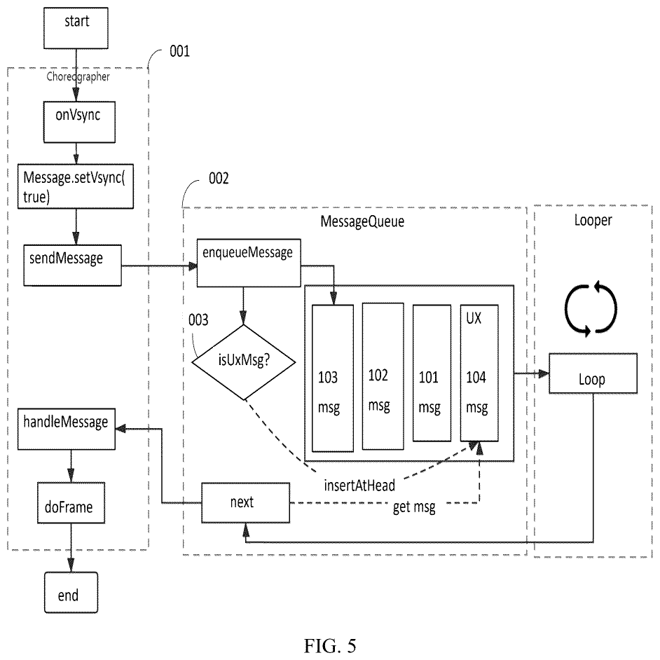

In one embodiment, as shown in FIG. 5, it is a flowchart of the method proposed in the embodiment of the present application. In FIG. 5, a message execution and processing method can be divided into two stages, namely a message generation stage 001 and a message execution stage 002.

In the message generation stage, the generated message can be identified and the type of the generated message can be obtained. When the type of the generated message is the preset target type, the identifying processing is performed on the generated message to obtain the flagged message. The flagged message is added to the message queue.

Choreographer is a message processor that can call back the methods proposed by the embodiments of the present application. on Vsync can refer to determining whether the type of the generated message is the preset target type. Message.setVsync (Truc) can mean that when the type of the generated message is the preset target type, the preset type identification field is added to the message structure of the generated message to obtain the initial identification message. Also, the preset type identification field of the initial identification message is activated to obtain the flagged message.

Then, the flagged message can be added to the message queue (enqueueMessage).

In the message execution stage, based on the preset type flag, the at least one message to be executed can be detected and the detection result can be obtained. For example, as shown in FIG. 5, a decision block 003 in FIG. 5 is to detect the at least one message to be executed and obtain the detection result. Next, based on the detection result, the target message to be executed with the preset type flag can be identified in the at least one message to be executed. For example, as shown in FIG. 5, a message to be executed (msg) 104 may be the target message to be executed. Then, the target message to be executed can be placed at the head of the message queue.

Then, the main thread acquires the message from the message queue in a next message loop. When starting to traverse the message queue, if the head of the message queue is the target message to be executed (for example, the paint message), it will be directly taken out for execution. This will give priority to the previously flagged message that is perceptible to the user, reducing the time it takes to traverse the queue to get the target message to be executed, thereby further improving the problem of delay in messages that are easily perceptible by the user.

The embodiment of present application proposes the message execution and processing method, which includes: acquiring at least one message to be executed in a message queue; detecting the at least one message to be executed based on a preset type flag to obtain a detection result; identifying a target message to be executed with the preset type flag in the at least one message to be executed based on the detection result; and updating execution position information of the target message to be executed in the message queue to obtain an updated message to be executed. In the embodiment of the present application, by updating the execution position message of the target message to be executed in the message queue, the updated message to be executed can be quickly executed by the main thread. Compared with the existing technology, the embodiment of the present application does not require the main thread to traverse the message queue to extract the target message to be executed. Therefore, compared with the prior art, the embodiment of the present application can reduce the time for the main thread to traverse the message queue, thereby improving the efficiency of the main thread to execute messages that are easily perceivable by the user.

In addition, in the embodiment of the present application, the message can be identified, the management of the user-perceivable message in the message queue can be optimized, the message strategy of user-perceivable message can be increased. Overall, the problem of user-perceived message delay caused by a large number of queue messages is reduced.

In the embodiments of the present application, the user-perceptible message is used as the paint message and corresponding tests are performed. The test data is shown in Table 1:

TABLE 1

| | UXMsg | | Optimization | |
|---|---|---|---|---|
| functional points | First | Normal | (ms) | Percentage |
| Message enqueue | 56.28 | 60.62 | 4.34 | 7% |
| optimization (directly | | | | |
| added to the head of | | | | |
| the queue, no need to | | | | |
| find and insert) | | | | |
| Message dequeuing | 34.23333330 | 42.5 | 8.266667 | 8% |
| optimization | | | | |

Test premise: There are more than 100 unprocessed messages in the message queue. At this time, a paint message is sent to compare a delay time of the paint message.

As can be seen from Table 1, by adding 100+ messages to the message queue and actively triggering execution, the delay of the paint message before optimization and the delay of the paint message after optimization are acquired. A total time for message entry and exit has been increased by more than 12 ms, an optimization of more than 20%.

In order to better implement the message execution and processing method provided by the embodiments of the present application, a message execution and processing device is also provided in one embodiment. The message execution and processing device can be integrated into the electronic device. The meaning of the terms is the same as in the above message execution and processing method. For specific implementation details, please refer to the description in the method embodiment.

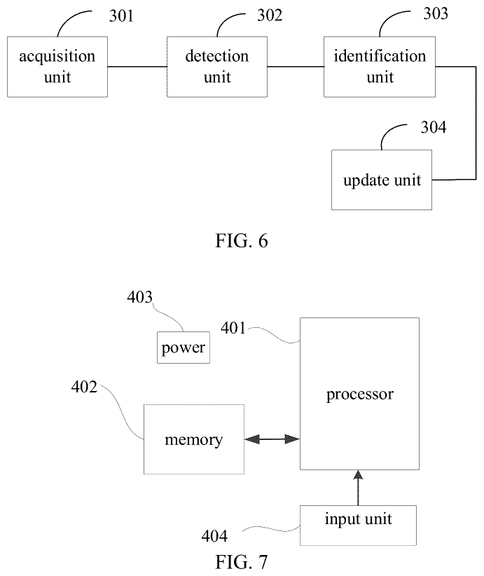

In one embodiment, a message execution and processing device is provided. The message execution and processing device can be integrated into an electronic device. As shown in FIG. 6, the message execution and processing device includes: an acquisition unit 301, a detection unit 302, an identification unit 303, and an update unit 304, as follows:

The acquisition unit 301 is configured to acquire at least one message to be executed in a message queue.

The detection unit 302 is configured to detect the at least one message to be executed based on a preset type flag to obtain a detection result.

The identification unit 303 is configured to identify a target message to be executed with the preset type flag in the at least one message to be executed based on the detection result.

The update unit 304 is configured to update execution position information of the target message to be executed in the message queue to obtain an updated message to be executed.

In an embodiment, the detection unit 302 may include:
a parsing subunit configured to parse the message to be executed to obtain a message structure of the message to be executed, where the message structure comprises a plurality of structural parameters;
a matching subunit configured to match the preset type flag and the structural parameters to obtain a matching result; and
a generating subunit configured to generate the detection result according to the matching result.

In an embodiment, the update unit 304 may include:
an information determination subunit configured to determine target update position information of the target message to be executed based on the execution position information;
a message determination subunit configured to determine an associated message to be executed associated with the target update position information;
an information adjustment subunit configured to adjust execution position information of the associated message to be executed; and
an information update subunit configured to update the execution position information of the target message to be executed to the target update position information to obtain the updated message to be executed.

In one embodiment, the detection unit is configured to:
detect the at least one message to be executed based on a preset paint type flag to obtain the detection result.

In one embodiment, the identification unit is configured to:
identify a target paint message to be executed with the preset paint type flag in the at least one message to be executed based on the detection result.

In one embodiment, the update unit is configured to:
update execution position information of the target paint message to be executed in the message queue to obtain the updated message to be executed.

In one embodiment, the message execution and processing device in the embodiment of the present application may also include:
a calling unit configured to call a main thread to execute the updated message to be executed.

In one embodiment, the message execution and processing device may include:
a message identification unit configured to identify a generated message to obtain a type of the generated message;
an identification unit configured to perform an identifying processing on the generated message to obtain a flagged message if the type of the generated message is a preset target type;
an addition unit configured to add the flagged message to the message queue.

In one embodiment, the identification unit may include:
a message identification subunit configured to identify the generated message to obtain a message structure of the generated message if the type of the generated message is the preset target type;
a field addition subunit configured to add a preset type identification field to the message structure of the generated message to obtain an initial identification message;
an activation subunit configured to activate the preset type identification field of the initial identification message to obtain the flagged message.

During specific implementation, each of the above units can be implemented as an independent entity, or can be combined in any way and implemented as the same or several entities. For the specific implementation of each of the above units, please refer to the previous method embodiments and will not be described again here.

The reliability of message execution and processing can be improved through the above message execution and processing device.

An embodiment of present application also provides an electronic device, which may include a terminal or a server. For example, the electronic device may be a server, such as a message execution processing server. As shown in FIG. 7, it shows a schematic structural diagram of a terminal in the embodiment of the present application, specifically as follows:

The electronic device may include components such as a processor 401 of one or more processing cores, a memory 402, a power 403, and an input unit 404 of one or more computer-readable storage medium. Those skilled in the art can understand that the structure of the electronic device shown in FIG. 7 does not constitute a limitation on the electronic device, which may include more or fewer components than shown in the figure, or combine certain components, or arrange different components.

The processor 401 is a control center of the electronic device, and is connected to various parts of the entire electronic device using various interfaces and lines. By running or executing a software program and/or a module stored in the memory 402, and calling data stored in the memory 402, the processor 401 performs various functions and data processing of the electronic device, thereby performing overall control on the electronic device. Alternatively, the processor 401 may include one or more processing cores. Preferably, the processor 401 may integrate an application processor and a modem processor. The application processor mainly processes an operating system, a user page, an application, and the like. The modem processor mainly processes wireless communication. It may be understood that the foregoing modem processor may alternatively not be integrated into the processor 401.

The memory 402 may be configured to store a software program and a module, and the processor 401 runs the software program and the module that are stored in the memory 402, to implement various functional applications and data processing. The memory 402 may mainly include a program storage area and a data storage area. The program storage area may store an operating system, an application required by at least one function (for example, a sound playback function and an image playback function), or the like. The data storage area may store data created according to use of the computer device. In addition, the memory 402 may include a high speed random access memory, and may also include a non-volatile memory, such as at least one magnetic disk storage device, a flash memory, or another volatile solid-state storage device. Correspondingly, the memory 402 may further include a memory controller, so that the processor 401 may access the memory 402.

The electronic device further includes the power 403 for supplying power to the components. Preferably, the power 403 may be logically connected to the processor 401 by using a power management system, thereby implementing functions such as charging, discharging, and power consumption management by using the power management system. The power 403 may further include one or more direct current or alternating current power supplies, a re-charging system, a power failure detection circuit, a power supply converter or inverter, a power supply state indicator, and any other component.

The electronic device may further include the input unit 404. The input unit 404 may be configured to receive input digit or character information and generate keyboard, mouse, joystick, optical, or trackball signal input related to user settings and function control.

Although not shown in the figure, the electronic device may further include a display unit, and the like. Details are not described herein again. In this embodiment, the processor 401 in the electronic device may load executable files corresponding to processes of one or more applications to the memory 402 according to the following instructions, and the processor 401 runs an application stored in the memory 402, to implement various functions as follows:
acquiring at least one message to be executed in a message queue;
detecting the at least one message to be executed based on a preset type flag to obtain a detection result;
identifying a target message to be executed with the preset type flag in the at least one message to be executed based on the detection result; and
updating execution position information of the target message to be executed in the message queue to obtain an updated message to be executed.

For the specific implementation of each of the above operations, please refer to the previous embodiments and will not be described again here.

According to one aspect of the present application, a computer program application or computer program is provided. The computer program application or the computer program includes computer instructions, the computer instructions being stored in a computer-readable storage medium. A processor of a computer device reads the computer instructions from the computer-readable storage medium and executes the computer instructions to cause the computer device to perform the methods provided in various optional implementations in the above embodiments.

Persons of ordinary skill in the art can understand that all or part of the steps in the various methods of the above embodiments can be completed by a computer program, or by controlling related hardware by a computer program. The computer program can be stored in a computer-readable storage medium and loaded and executed by the processor.

To this end, an embodiment of the present application also provides a storage medium in which the computer program is stored. The computer program can be loaded by a processor to perform steps in any message execution and processing method provided by the embodiments of the present application. For example, this computer program can perform the following steps:
acquiring at least one message to be executed in a message queue;
detecting the at least one message to be executed based on a preset type flag to obtain a detection result;
identifying a target message to be executed with the preset type flag in the at least one message to be executed based on the detection result; and
updating execution position information of the target message to be executed in the message queue to obtain an updated message to be executed.

For the specific implementation of each of the above operations, please refer to the previous embodiments and will not be described again here.

The computer program stored in the storage medium can execute steps in any message execution and processing method provided by the embodiments of the present application. Therefore, the beneficial effects that can be achieved by any message execution and processing method provided by the embodiments of the present application can be achieved. Please refer to the previous embodiments for details and will not be described again here.

The message execution and processing method, the device, the electronic device, and the storage medium provided by the embodiments of the present disclosure are described above in detail. The principles and implementations of the present disclosure are described in this specification by using specific examples, and the descriptions of the above embodiments are only used to help understand the method and the core idea of the present disclosure. Meanwhile, for those skilled in the art, according to the idea of the present disclosure, there will be changes in the specific implementation manner and application scope. In conclusion, the content of this specification should not be construed as a limitation on the present disclosure.

1. A message execution and processing method, comprising:
acquiring at least one message to be executed in a message queue;
detecting the at least one message to be executed based on a preset type flag to obtain a detection result;
identifying a target message to be executed with the preset type flag in the at least one message to be executed based on the detection result; and
updating execution position information of the target message to be executed in the message queue to obtain an updated message to be executed.

2. The method according to claim 1, wherein detecting the at least one message to be executed based on a preset type flag to obtain a detection result comprises:
parsing the message to be executed to obtain a message structure of the message to be executed, wherein the message structure comprises a plurality of structural parameters;
matching the preset type flag and the structural parameters to obtain a matching result; and
generating the detection result according to the matching result.

3. The method according to claim 1, wherein updating execution position information of the target message to be executed in the message queue to obtain an updated message to be executed comprises:
determining target update position information of the target message to be executed based on the execution position information;
determining an associated message to be executed associated with the target update position information;
adjusting execution position information of the associated message to be executed; and
updating the execution position information of the target message to be executed to the target update position information to obtain the updated message to be executed.

4. The method according to claim 3, wherein adjusting execution position information of the associated message to be executed comprises:
acquiring an empty queue; and
storing the associated message to be executed in the empty queue;
wherein after updating the execution position information of the target message to be executed to the target update position information to obtain the updated message to be executed, the method further comprises:
according to an execution order of the associated message to be executed, adding the associated message to be executed in the empty queue to the message queue.

5. The method according to claim 1, wherein the preset type flag comprises a preset paint type flag; and detecting the at least one message to be executed based on a preset type flag to obtain a detection result comprises:
detecting the at least one message to be executed based on a preset paint type flag to obtain the detection result;
wherein identifying a target message to be executed with the preset type flag in the at least one message to be executed based on the detection result comprises:
identifying a target paint message to be executed with the preset paint type flag in the at least one message to be executed based on the detection result;
wherein updating execution position information of the target message to be executed in the message queue to obtain an updated message to be executed comprises:
updating execution position information of the target paint message to be executed in the message queue to obtain the updated message to be executed.

6. The method according to claim 1, wherein the method further comprises:
calling a main thread to execute the updated message to be executed.

7. The method according to claim 1, wherein before acquiring at least one message to be executed in a message queue, the method further comprises:
identifying a generated message to obtain a type of the generated message;
if the type of the generated message is a preset target type, performing an identifying processing on the generated message to obtain a flagged message;
adding the flagged message to the message queue.

8. The method according to claim 7, wherein if the type of the generated message is a preset target type, performing an identifying processing on the generated message to obtain a flagged message comprises:
if the type of the generated message is the preset target type, identifying the generated message to obtain a message structure of the generated message;
adding a preset type identification field to the message structure of the generated message to obtain an initial identification message;
activating the preset type identification field of the initial identification message to obtain the flagged message.

9. The method according to claim 7, wherein if the type of the generated message is a preset target type, performing an identifying processing on the generated message to obtain a flagged message comprises:
if the type of the generated message is the preset target type, acquiring an identification;
adding the identification to the generated message to obtain a flagged message.

10. The method according to claim 1, wherein identifying a target message to be executed with the preset type flag in the at least one message to be executed based on the detection result comprises:
if the detection result is true, identifying the target message to be executed with the preset type flag in the at least one message to be executed based on the detection result.

11. The method according to claim 1, wherein identifying a target message to be executed with the preset type flag in the at least one message to be executed based on the detection result comprises:
if the detection result is 1, identifying the target message to be executed with the preset type flag in the at least one message to be executed based on the detection result.

12. A message execution and processing device, comprising:
an acquisition unit configured to acquire at least one message to be executed in a message queue;
a detection unit configured to detect the at least one message to be executed based on a preset type flag to obtain a detection result;
an identification unit configured to identify a target message to be executed with the preset type flag in the at least one message to be executed based on the detection result; and
an update unit configured to update execution position information of the target message to be executed in the message queue to obtain an updated message to be executed.

13. The message execution and processing device according to claim 12, wherein the detection unit comprises:
a parsing subunit configured to parse the message to be executed to obtain a message structure of the message to be executed, wherein the message structure comprises a plurality of structural parameters;
a matching subunit configured to match the preset type flag and the structural parameters to obtain a matching result; and
a generating subunit configured to generate the detection result according to the matching result.

14. The message execution and processing device according to claim 12, wherein the update unit comprises:
an information determination subunit configured to determine target update position information of the target message to be executed based on the execution position information;
a message determination subunit configured to determine an associated message to be executed associated with the target update position information;
an information adjustment subunit configured to adjust execution position information of the associated message to be executed; and
an information update subunit configured to update the execution position information of the target message to be executed to the target update position information to obtain the updated message to be executed.

15. The message execution and processing device according to claim 14, wherein the information adjustment subunit is configured to:
acquire an empty queue;
store the associated message to be executed in the empty queue; and
according to an execution order of the associated message to be executed, add the associated message to be executed in the empty queue to the message queue.

16. The message execution and processing device according to claim 12, wherein the preset type flag comprises a preset paint type flag, and the detection unit is configured to:
detect the at least one message to be executed based on a preset paint type flag to obtain the detection result;
wherein the identification unit is configured to:
identify a target paint message to be executed with the preset paint type flag in the at least one message to be executed based on the detection result;
wherein the update unit is configured to:
update execution position information of the target paint message to be executed in the message queue to obtain the updated message to be executed.

17. The message execution and processing device according to claim 12, wherein the message execution and processing device further comprises:
a calling unit configured to call a main thread to execute the updated message to be executed.

18. The message execution and processing device according to claim 12, wherein the message execution and processing device further comprises:
a message identification unit configured to identify a generated message to obtain a type of the generated message;
an identification unit configured to perform an identifying processing on the generated message to obtain a flagged message if the type of the generated message is a preset target type;
an addition unit configured to add the flagged message to the message queue.

19. An electronic device, comprising a memory and a processor, the memory storing a computer program, and the processor being configured to run the computer program in the memory to perform;
acquiring at least one message to be executed in a message queue;
detecting the at least one message to be executed based on a preset type flag to obtain a detection result:
identifying a target message to be executed with the preset type flag in the at least one message to be executed based on the detection result; and
updating execution position information of the target message to be executed in the message queue to obtain an updated message to be executed.

20. (canceled)

21. The electronic device according to claim 19, wherein the processor is further configured to:
parse the message to be executed to obtain a message structure of the message to be executed, wherein the message structure comprises a plurality of structural parameters;
match the preset type flag and the structural parameters to obtain a matching result; and
generate the detection result according to the matching result.
